(19) United States
(12) Patent Application Publication
(10) Pub. No.: US 2016/0155211 A1
(43) Pub. Date: Jun. 2, 2016

(54) DISPLAY DEVICE AND RECORDING MEDIUM USED FOR ON-SCREEN OPERATION SUCH AS SWIPE OPERATION

(71) Applicant: KYOCERA Document Solutions Inc., Osaka (JP)

(72) Inventor: Hideyuki SASAKI, Osaka (JP)

(73) Assignee: KYOCERA Document Solutions Inc., Osaka (JP)

(21) Appl. No.: 14/943,598

(22) Filed: Nov. 17, 2015

(30) Foreign Application Priority Data
Nov. 28, 2014 (JP) 2014-242315

(51) Int. Cl. G06T 3/20; G06F 3/0486; G06T 7/20; G06T 11/60; G06T 1/20

(52) U.S. Cl. CPC G06T 3/20; G06T 11/60; G06T 1/20; G06T 7/20; G06F 3/0486

(57) ABSTRACT

According to the present disclosure, a display device includes a processor having one or more of circuits. The processor includes an image-drawing processing unit, a selection receiving unit, a movement detecting unit, a movement processing unit, a processing capacity determining unit, and a movement managing unit. The image-drawing processing unit draws an image on a screen of an image forming apparatus. The selection receiving unit receives selection of the image. The movement detecting unit detects movement of a selection position with respect to the image on the screen. The movement processing unit makes the image move. The processing capacity determining unit determines whether the processing capacity is equal to or lower than a first threshold. The movement managing unit performs movement management to prohibit the image from moving where the processing capacity falls out of an acceptable range.

### INCORPORATION BY REFERENCE

This application is based upon and claims the benefit of priority from the corresponding Japanese Patent Application No. 2014-242315 filed on Nov. 28, 2014, the entire contents of which are incorporated herein by reference.

### BACKGROUND

The present disclosure relates to display devices and recording media used for operations such as a swipe operation performed on screens of electronic apparatuses.

Known as typical examples of such electronic apparatuses are tablet terminals, multi-functional mobile phones, and the like that include a touch-panel screen to allow an intuitive operation by means of a user's finger to be performed with respect to an image displayed on the screen with his/her finger.

Various intuitive operations are possible for various purposes, and, for example, a swipe operation is often used to switch images displayed on the screen. The swipe operation is an operation of slidingly moving a finger touching a screen on the screen, and then detaching the finger from the screen.

In switching images displayed on the screen through the swipe operation, an intuitive operation is realized by making an image move on the screen following a movement of a finger touching the screen.

Here, in processing performed on the apparatus side, an image is drawn continuously at an image-drawing interval based on processing capacity of the apparatus, and meanwhile, a position of the continuously drawn image is changed based on moving speed of the finger.

Here, for a smooth movement of the image, a shorter image-drawing interval is more advantageous; for example, with an image-drawing interval of as small as 1/60 seconds (60 fps), followability of the image with respect to the finger becomes high, and this helps realize a smooth movement of the image. Even with a longer image-drawing interval of about ⅛ (8 fps), although the movement of image may appear to be delayed with respect to the movement of the finger, the followability of the image can still be regarded as acceptable.

However, when the image-drawing interval becomes yet longer, the image may appear to flicker when moving. It is possible to address this problem by forcibly setting the image-drawing interval short, but such setting of the image-drawing interval may exclusively occupy resources such as a CPU usage rate, which may have adverse effects on other processing performed in background.

Such inconveniences are experienced also with non-touch-panel type electronic apparatuses, such as those which accept a swipe operation performed by means of a pointing device such as a mouse.

### SUMMARY

According to an aspect of the present disclosure, a display device includes a processor having one or more of circuits. The processor includes an image-drawing processing unit, a selection receiving unit, a movement detecting unit, a movement processing unit, a processing capacity determining unit, and a movement managing unit. The image-drawing processing unit draws an image on a screen of an apparatus at an image-drawing interval based on a processing capacity of the apparatus. The selection receiving unit receives selection of the image drawn on the screen. The movement detecting unit detects, in a state where the image has been selected, a movement of a selection position with respect to the image on the screen. The movement processing unit makes the image move following the movement of the selection position that has been detected. The processing capacity determining unit determines whether the processing capacity is equal to or lower than a first threshold. The movement managing unit performs movement management in which, in a case where the processing capacity is found to be equal to or lower than the first threshold, the movement managing unit prohibits the image from moving when followability of the image with respect to the movement of the selection position falls out of the acceptable range based on the image-drawing interval.

Still other objects and specific advantages of the present disclosure will become apparent from the following descriptions of embodiments.

### BRIEF DESCRIPTION OF THE DRAWINGS

FIG. 1 illustrates an image forming apparatus in which a display device of the present disclosure is incorporated (Example 1);

FIG. 2 illustrates an example of a screen on which movement of an image of the present disclosure is conceptually illustrated (Example 1);

FIG. 3 illustrates an outline of display processing of the present disclosure (Example 1);

FIG. 4 illustrates steps in capacity determining processing performed in the display processing of the present disclosure (Example 1);

FIG. 5 illustrates steps in movement managing processing performed in cases of medium and high capacities in the display processing of the present disclosure (Example 1);

FIG. 6 illustrates steps in movement managing processing performed in a case of a low capacity in the display processing of the present disclosure (Example 1);

FIG. 7 illustrates steps in the image switching processing performed in the display processing according to the present disclosure (Example 1); and

FIG. 8 illustrates an image forming apparatus in which a display device of the present disclosure is incorporated (Example 2).

### DETAILED DESCRIPTION

The object of preventing flickering of an image in moving the image on a screen following a movement of a finger, a pointing device, or the like has been achieved by means of a display device that manages the movement of an image based on processing capacity of an apparatus and that prohibits movement of such an image as may be caused to flicker.

The display device is generally usable in electronic apparatuses that make an image move on a screen following a movement of a finger, a pointing device, etc. Examples of such electronic apparatuses include information processing devices such as personal computers and multi-function mobile phones such as smart phones, image forming apparatuses such as printers and digital multifunction peripherals, and in addition to these, household electric appliances. In examples of the present disclosure, a display device is incorporated in an image forming apparatus.

### Example 1

### Configuration of Image Forming Apparatus

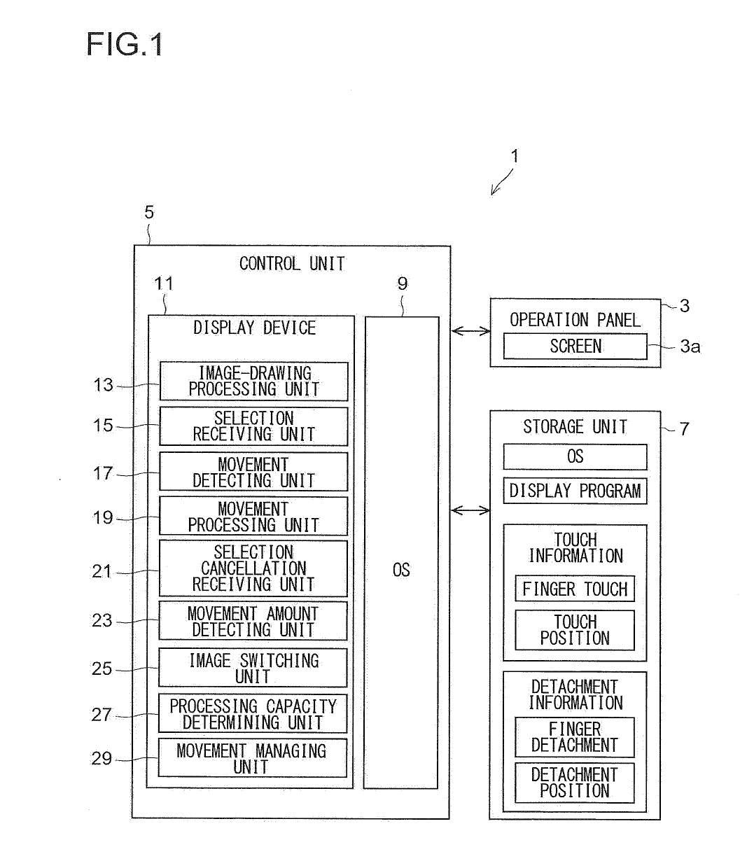

FIG. 1 illustrates an image forming apparatus in which a display device is incorporated.

The image forming apparatus 1 is a printer, a digital multifunction peripheral, or the like, and includes components such as an operation panel 3, a control unit 5, and a storage unit 7 as illustrated in FIG. 1. The image forming apparatus 1 has various kinds of functions including a printing function.

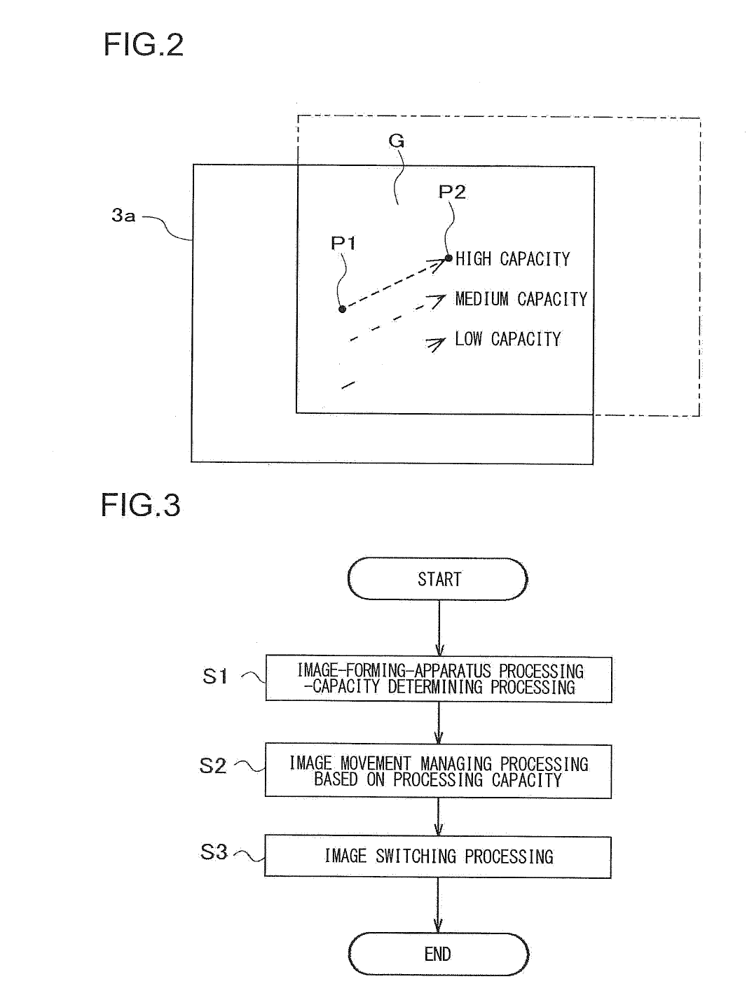

The operation panel 3 has a circuit including a touch-panel type screen 3a constituted by, for example, liquid crystal. On the operation panel 3, operation inputs for realizing functions of the image forming apparatus 1 and display of the operation status of the image forming apparatus 1, for example, are performed through operations with respect to an image G on the screen 3a (see FIG. 2). At a time of an operation input and the like, the operation panel 3 of Example 1 allows an operation input and the like to be performed as a swipe operation with a user's finger, for example, to switch the image G on the screen 3a to another image G. As is commonly known, the swipe operation is an operation of slidingly moving a finger touching the screen 3a on the screen 3a and then detaching the finger from the screen 3a.

The control unit 5 is a processor as a computer, and includes an arithmetic element such as a central processing unit (CPU), and controls various units of the image forming apparatus 1. The control unit 5 is a processor having one or more circuits. The control unit 5 is capable of reading and executing various programs, and is also capable of executing various programs installed in advance. Here, the one ore more circuits may each be an electronic component or an electronic substrate where a plurality of electronic elements are connected by means of wiring. The control unit 5 has an arithmetic capacity defined by a clock frequency and the number of instructions executable per clock.

The arithmetic capacity, as a resource, together with, for example, capacity of the storage unit 7, determines the specific processing capacity (the basic performance) of the image forming apparatus 1. Here, the processing capacity of the image forming apparatus 1 during operation decreases with respect to the specific processing capacity based on an amount of resource consumption for controlling each unit, for example.

The storage unit 7 is a storage device, and includes a read-only memory (ROM) in which data necessary for processing is stored, a random access memory (RAM) that serves as a work area, a hard disk drive (HDD) that serves as an auxiliary storage device, etc. The storage unit 7 of Example 1 has an area where an operating system (OS), a display program, and the like are stored.

By being executed at the control unit 5, the OS realizes functions for basic management and control of the image forming apparatus 1. In Example 1, an OS 9 executed at the control unit 5 manages touch, detachment, and movement of a finger performed with respect to the operation panel 3.

By being executed at the control unit 5 (on the OS 9), the display program makes the control unit 5 function as various units of a display device 11. That is, the control unit 5 functions as an image-drawing processing unit 13, a selection receiving unit 15, a movement detecting unit 17, a movement processing unit 19, a selection cancellation receiving unit 21, a movement amount detecting unit 23, an image switching unit 25, a processing capacity determining unit 27, and a movement managing unit 29.

The image-drawing processing unit 13 realizes an image-drawing processing function, and draws an image on the screen 3a of the image forming apparatus 1 at an image-drawing interval based on the processing capacity of the image forming apparatus 1. Thus, as a result of the image drawing, an image is displayed on the screen 3a. FIG. 2 illustrates an example of the screen 3a. Note that FIG. 2 conceptually illustrates movement of an image G following a movement of a finger which will be described later.

The image-drawing interval is set such that an upper limit thereof is 1/60 second, and the image-drawing processing unit 13 can draw a plurality of frames of the image G in one second, on the screen 3a, based on the image-drawing interval.

The image-drawing interval is reciprocal to the number of frames of the image G that can be drawn in one second (frame rate: frames per second (fps)), and the image-drawing interval varies based on the processing capacity while the image forming apparatus 1 is operating. For example, when the processing capacity of the image forming apparatus 1 is lowered, so that the frame rate is lowered, the image-drawing interval becomes longer.

The selection receiving unit 15 realizes a selection receiving function, and receives selection of the image G drawn on the screen 3a. The selection receiving unit 15 of Example 1 receives a touch of a user's finger on the screen 3a as an act of selecting the image G. That is, when the user touches the screen 3a with his/her finger, the selection receiving unit 15 is notified, by the OS 9, of the finger touch and a touch position (coordinates) P1 where the finger touch has been performed. Thereby, the selection receiving unit 15 receives the finger touch on the screen 3a performed at the touch position P1. The touch position P1 of the finger touch on the screen 3a is stored in the storage unit 7 as touch information.

The movement detecting unit 17 realizes a movement detecting function, and, in a state where the image G has been selected, detects a movement of a selection position with respect to the image G on the screen 3a. That is, the movement detecting unit 17 detects a movement of the finger touching the screen 3a. Specifically, when the finger touching the screen 3a is slidingly moved from the touch position P1 on the screen 3a, the OS 9 notifies the movement detecting unit 17 of a series of continuous touch positions that indicate a track of the movement of the finger. Thereby, the movement detecting unit 17 can detect the movement of the finger, which is touching the screen 3a, on the screen 3a.

The movement processing unit 19 realizes a moving processing function, and makes the image G move on the screen 3a following the movement of the selection position detected by the movement detecting unit 17. That is, by moving the image G on the screen 3a parallel based on the series of continuous touch positions notified from the OS 9, the movement processing unit 19 makes the image G on the screen 3a move following the movement of the finger.

The selection cancellation receiving unit 21 realizes a selection cancellation receiving function, and receives detachment of the finger from the screen 3a as cancellation of the selection of the image G. When the user detaches his or her finger from the screen 3a, the OS 9 notifies the selection cancellation receiving unit 21 of the detachment of the finger and a detachment position P2 at which the user has detached his or her finger from the screen 3a. Thereby, the selection cancellation receiving unit 21 receives information indicating that the finger has been detached from the screen 3a at the detachment position P2. Detachment information indicating the detachment of the finger and the detachment position P2 is then stored in the storage unit 7 as detachment information.

The movement amount detecting unit 23 realizes a movement amount detecting function, and detects a movement amount between the touch position (selection position) P1 received by the selection receiving unit 15 and the detachment position (cancellation position) P2 received by the selection cancellation receiving unit 21.

In Example 1, detected here is a movement amount of the image G in a horizontal or vertical direction on the screen 3a having a rectangular shape. That is, as the movement amount, a horizontal component and a vertical component of a line connecting the touch position P1 and the detachment position P2 are detected.

The image switching unit 25 realizes an image switching function, and in a case where the movement amount detected by the movement amount detecting unit 23 is equal to or larger than a switching threshold, the image switching unit 25 switches from the image G, which is currently being drawn, to another image. That is, the image switching unit 25 gives the image processing unit 13 an instruction to draw another image to achieve the switching of images.

The processing capacity determining unit 27 and the movement managing unit 29 are provided to manage the movement of the image G following the movement of the finger, which is achieved by the movement processing unit 19.

The processing capacity determining unit 27 realizes a processing capacity determining function, and determines whether or not the processing capacity of the image forming apparatus 1 is equal to or lower than a first threshold. The processing-capacity judgment in Example 1 is performed while the image forming apparatus 1 is operating. Specifically, a judgment is made on an actual processing capacity of the image forming apparatus 1 that has decreased with respect to the specific processing capacity of the image forming apparatus 1 based on the amount of resource consumption.

The actual processing capacity can be obtained by means of an actual value of the frame rate measured immediately before the image G moves. Or, the actual processing capacity may be obtained by means of the specific processing capacity of the image forming apparatus 1 and an actually measured value of the magnitude of the amount of resource consumption including, for example, a CPU usage rate of the control unit 5 and a memory consumption amount of the storage unit 7.

As the processing-capacity judgment performed in Example 1, a judgment is made on whether the processing capacity of the image forming apparatus 1 is a low capacity that is equal to or lower than the first threshold, a medium capacity that is higher than the first threshold but equal to or lower than a second threshold, or a high capacity that is higher than the second threshold.

The high capacity is a processing capacity that makes it possible to draw an image at an image-drawing interval that is equal or close to an upper limit (for example, 1/60 seconds) of a set image-drawing interval, even if an amount of resource consumption for other processing is taken into consideration. The medium capacity is a processing capacity of a case where the amount of resource consumption has increased from that of the case of the high capacity. Even with the medium capacity, it might be possible to draw the image G at an image-drawing interval taken in the case of the high capacity, that is, for example, at the upper limit image-drawing interval, but if the amount of resource consumption for other processing is taken into consideration, it becomes difficult to draw the image G at the image-drawing interval taken in the case of the high capacity. The low capacity is a processing capacity of a case where the amount of resource consumption has increased from that of the case of the medium capacity. With the low capacity, even if the amount of resource consumption amount for other processing is not taken into consideration, it is difficult to draw the image G at the image-drawing interval taken in the case of the high capacity.

Thus, with the high and medium processing capacities, based on the image-drawing interval based on each processing capacity, the followability of the movement of the image G with respect to the movement of the finger falls within an acceptable range. In contrast, with the low capacity, based on the image-drawing interval corresponding to the processing capacity, the followability of the movement of the image G with respect to the movement of the finger, which is the movement of the selection position, falls out of the acceptable range.

In FIG. 2, arrows indicate the movements of the image G and the finger, and broken lines indicate image-drawing intervals.

As illustrated in FIG. 2, within the acceptable range of the followability (that is, in the cases of the medium and high capacities), although depending on moving speed of the finger, it is possible to make the image G move following the movement of the finger smoothly or with some delay to make the user recognize a course of the movement of the image G. Out of the acceptable range of the followability (in the case of the low capacity), although depending on the moving speed of the finger, the image G does not follow the finger and appears to flicker, and thus it is impossible to make the user recognize the course of the movement of the image G.

The movement managing unit 29 realizes a movement managing processing, and performs movement management in which, in a case where the processing capacity of the image forming apparatus 1 is the low capacity that is equal to or lower than the first threshold, the movement managing unit 29 prohibits the image G from moving when followability of the image G with respect to the movement of the finger falls out of the acceptable range based on the image-drawing interval. Thus, in the movement management, in the case where the processing capacity is the medium capacity or the high capacity, the image G is allowed to move.

Further, in the case of the medium capacity, based on the amount of resource consumption that increases with respect to that of the case of the high capacity, the movement managing unit 29 forcibly sets the image-drawing interval of the case of the medium capacity longer than the image-drawing interval of the case of the high capacity. The value of the image-drawing interval to be set in this case is determined in advance to be, for example, ⅛ seconds.

[Display Processing]

FIG. 3 shows an outline of display processing.

In display processing of Example 1, an image G drawn on the screen 3a of the operation panel 3 is switched by a swipe operation, and the display processing is started by the drawing on the screen 3a the image G, which is a target of the swipe operation.

In step S1, “image-forming-apparatus processing-capacity determining processing” is performed, and as will be described later, a judgment is made on the actual processing capacity of the image forming apparatus 1. When step S1 is completed in this way, the process proceeds to step S2.

In step S2, “image movement managing processing based on processing capacity” is performed. In the movement managing processing, in a case of a swipe operation performed on the screen 3a of the image forming apparatus 1, based on the processing capacity of the image forming apparatus 1, the image G is prohibited from moving, or allowed to move, following a movement of a finger.

In the case where the processing capacity is the low capacity, the image G is prohibited from moving following the movement of the finger. That is, even when a swipe operation is performed, the image G remains stationary without moving. On the other hand, in the case where the processing capacity is the medium capacity or the high capacity, the image G is allowed to move following the movement of the finger.

Step S2 is completed in this way, and then the process proceeds to step S3.

In step S3, “image switching processing” is performed. That is, in the image switching processing, image switching is performed based on a movement amount of the image G in the swipe operation from when the finger touches the screen 3a to when the finger is detached from the screen 3a.

[Capacity Determining Processing]

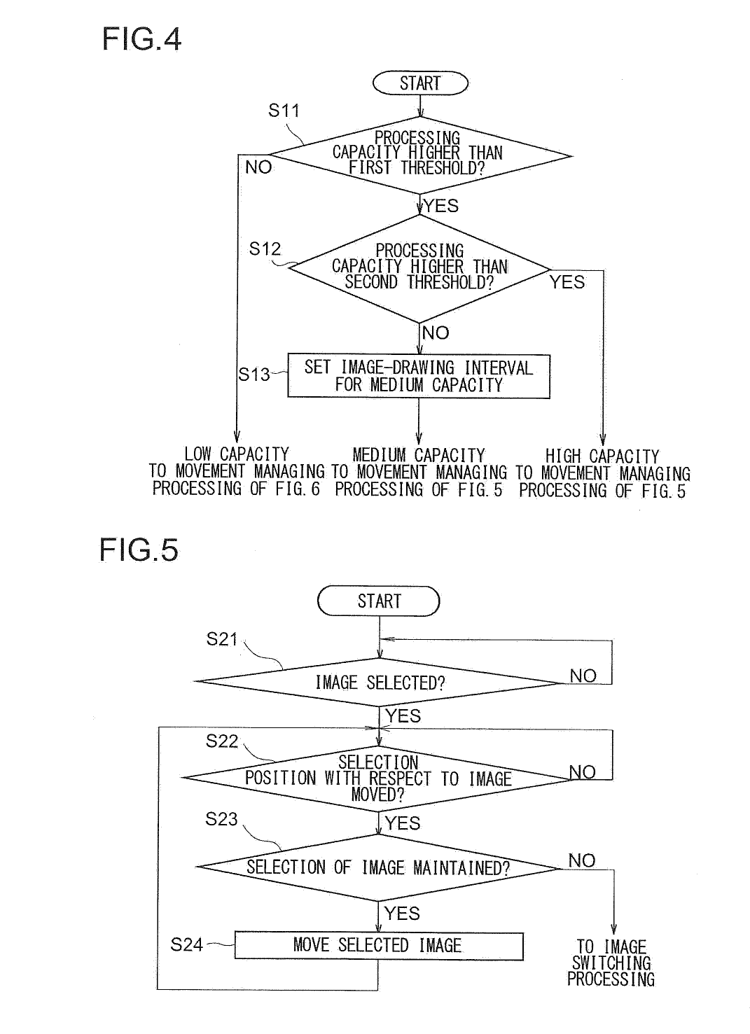

FIG. 4 illustrates steps in capacity determining processing.

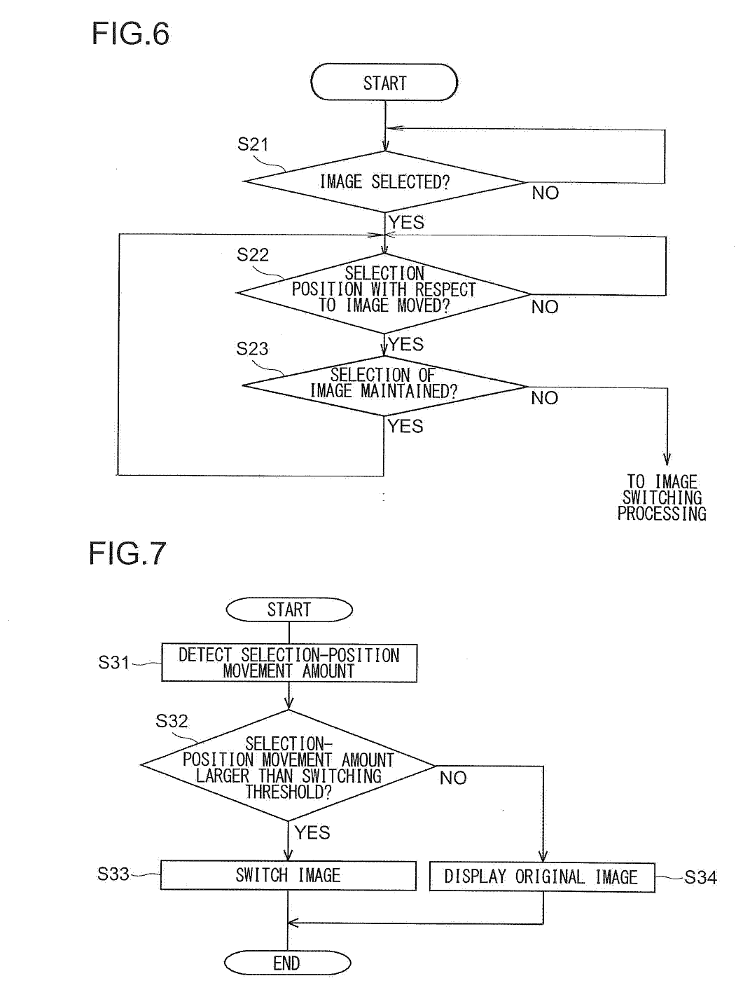

Capacity determining processing of Example 1 is performed periodically after the display processing is started, or the capacity determining processing of Example 1 is performed at a start of the movement managing processing illustrated in FIG. 5 or 6. In a case where the capacity determining processing is performed at the time of the movement managing processing, the capacity determining processing is performed immediately after step S21 in the movement managing processing (see FIGS. 5 and 6), for example.

In step S11 in the capacity determining processing, processing of making a judgment on “is the processing capacity higher than the first threshold?” is performed. That is, the processing capacity determining unit 27 obtains an actual processing capacity of the image forming apparatus 1 by means of an actually measured value of the frame rate or by means of a combination of the specific processing capacity and an actually measured value of amount of resource consumption, and the processing capacity determining unit 27 determines whether the thus obtained processing capacity is higher than the first threshold.

In a case where the processing capacity is found to be higher than the first threshold (YES in step S11), it is determined that the processing capacity is the medium capacity or the high capacity, and the process proceeds to step S12, but in a case where the processing capacity is found to be equal to or lower than the first threshold (NO in step S11), it is determined that the processing capacity is the low capacity, and the process proceeds to the movement managing processing illustrated in FIG. 6.

In step S12, judgment on “the processing capacity is higher than the second threshold?” is made. That is, the processing capacity determining unit 27 determines whether the processing capacity of the image forming apparatus 1 is higher than the second threshold.

In a case where the processing capacity is found to be higher than the second threshold (YES in step S12), it is determined that the processing capacity is the high capacity, and the process proceeds to the movement managing processing of the cases of the medium and high capacities illustrated in FIG. 5. In a case where the processing capacity is found to be equal to or lower than the second threshold (NO in step S12), it is determined that the processing capacity is the medium capacity, and the process proceeds to step S13.

Here, the order of performance of the processing of steps S11 and S12 may be reversed.

In step S13, “setting of the image-drawing interval for the case of medium capacity” is performed. That is, based on the amount of resource consumption that increases with respect to that of the case of the high capacity, the movement managing unit 29 forcibly sets the image-drawing interval of the case of the medium capacity longer than that of the case of the high capacity, that is, specifically, at ⅛ second (8 fps), for example.

Step S13 is completed in this way, and the process proceeds to the movement managing processing of the cases of the medium and high capacities illustrated in FIG. 5.

The capacity determining processing may be performed at a startup of the image forming apparatus 1. Determined in the capacity determining processing performed at the startup is whether the specific processing capacity (the basic performance) of the image forming apparatus 1 is the low capacity, the medium capacity, or the high capacity. By thus determining the specific processing capacity of the image forming apparatus 1 at the startup, it is possible to reduce a burden of performing the capacity determining processing while the image forming apparatus 1 is operating.

That is, in a case where the specific processing capacity is the low capacity, the processing capacity during operation is also the low capacity naturally, and thus, performance of the capacity determining processing during operation can be omitted. In a case where the specific processing capacity is the medium capacity, the capacity determining processing during operation is completed by performing only step S1. And, only in a case where the specific processing capacity is the high capacity, the capacity determining processing during operation is performed as described above.

[Movement Managing Processing in Cases of Medium and High Capacities]

FIG. 5 is a flow chart illustrating movement managing processing performed in cases of the medium and high capacities.

In the movement managing processing, processing of making a judgment on “has an image been selected?” is performed in step S21. That is, the selection receiving unit 15 determines, based on whether a notification has been received from the OS 9, whether the user's finger has touched the screen 3a as an act of selecting an image G on the screen 3a.

In a case where it is determined that there has been a finger touch on the screen 3a (YES in step S21), the finger touch and a touch position P1 are stored as touch information in the storage unit 7, and the process proceeds to step S22, but otherwise (NO in step S21), the processing of step S21 is repeatedly performed until the user touches the screen 3a with his/her finger.

In step S22, processing of making a judgment on “has the selection position with respect to the image been moved?” is performed. That is, the movement detecting unit 17 determines, based on whether a notification has been received from the OS 9, whether the touch position of the user's finger as the selection position with respect to the image G with respect to the screen 3a has moved from the initial touch position P1.

In a case where the touch position of the finger is found to have moved (YES in step S22), the process proceeds to step S23, but in a case where the touch position of the finger is found not to have moved (NO in step S22), the processing of step S22 is repeated.

In a case where a simple touch operation is performed, that is, in a case where a finger touches the screen 3a but is then detached from the screen 3a without moving on the screen 3a, it is not the movement managing processing but touch operation processing that is performed. The touch operation processing is well known, and thus a description thereof will be omitted.

In step S23, processing of making a judgment on “is the image selection maintained?” is performed. That is, the selection cancellation receiving unit 21 determines whether the finger touch found in step S21 is maintained.

For example, the selection cancellation receiving unit 21 can determine whether the finger touch is maintained, based on the touch information stored in the storage unit 7. Or, the selection cancellation receiving unit 21 can determine whether the finger touch is maintained, based on the presence/absence of a notification, from the OS 9, of detachment of the finger from the screen 3a as an act of cancelling the selection of the image G.

Here, making the judgment based on the touch information stored in the storage unit 7 is advantageous in a case where the finger touch is maintained. That is, in the case of making a judgment on detachment of the finger by means of the detachment information stored in the storage unit 7, it is assumed that there has been received, from the OS 9, a notification of the detachment of the finger. By means of this notification, it is possible to make judgment on whether the finger has been detached from the screen 3a.

In a case where the finger touch is found to be maintained (YES in step S23), the process proceeds to step S24, but in a case where the finger is found to have been detached from the screen 3a (NO in step S23), the detachment of the finger and a detachment position P2 based on the notification from the OS 9 is stored as detachment information in the storage unit 7, and the process proceeds to image switching processing illustrated in FIG. 7.

In step S24, “moving of the selected image G” is performed. That is, as shown in FIG. 2, the movement processing unit 19 makes the drawn image G move following the movement of the finger on the screen 3a by moving the drawn image G parallel based on a current touch position of the finger.

At this time, in the case of the high capacity, the image G during the movement is drawn at an image-drawing interval that is equal or close to the upper-limit image-drawing interval, and thus it is possible to make the image G move smoothly following the movement of the finger.

In the case of the medium capacity, the moving image G is drawn at an image-drawing interval that has forcibly been set long, and thus, it is possible to eliminate risk of the amount of resource being exclusively allotted to the drawing of the image at the same image-drawing interval as in the case of the high capacity, and this makes it possible to perform the processing of making the image G move, along with other processing, while ensuring a stable operation of the image forming apparatus 1. Here, during the movement of the image G in this case, the image G may sometimes appear not to be following the movement of the finger fast enough, but flickering of the image G does not become so bad as annoying.

When step S24 is completed in this way, the process returns to step S22, and the process is repeated.

[Movement Managing Processing Under Low Capacity]

FIG. 6 is a flow chart illustrating movement managing processing performed in the case of the low capacity.

The movement managing processing of the case of the low capacity is different from that of the cases of the medium and high capacities in that step S24 is omitted.

That is, the processing of making a judgment on “is the image selection maintained?” is performed in step S23, and in the case where the finger touch as an act of selecting the image G is found to be maintained (YES in step S23), the movement managing processing of the case of the low capacity is to be performed; that is, the process returns to step S22 without making the image G follow the image G even when the finger moves.

In the case of the low capacity, the followability of the movement of the image G with respect to the movement of the finger falls out of the acceptable range, and the image G does not follow the finger and thus appears to flicker, but here, it is possible to prevent the flickering of the image G by prohibiting the movement of such an image G.

On the other hand, in the case where the finger is found to have been detached from the screen 3a (No in step S23), the process proceeds to the image switching processing illustrated in FIG. 7.

[Image Switching Processing]

FIG. 7 illustrates steps in image switching processing.

In step S31, “detection of the movement amount of the selection position” is performed. That is, based on the initial touch position P1 and the detachment position P2, which is the last touch position, stored in the storage unit 7, the movement amount detecting unit 23 obtains, as the movement amount, a horizontal component and a vertical component of a line connecting the initial touch position P1 and the detachment position P2.

When step S31 is completed in this way, the process proceeds to step S32.

In step S32, processing of making a judgment on “is the movement amount of the selection position above the switching threshold?” is performed. That is, the image switching unit 25 determines whether the horizontal component and the vertical component which are the movement amount detected by the movement amount detecting unit 23 are equal to or larger than the switching threshold.

In a case where the movement amount is found to be larger than the switching threshold (YES in step S32), the process proceeds to step S33, and in a case where the movement amount is equal to or smaller than the switching threshold (NO in step S32), the process proceeds to step S34.

In step S33, “image switching processing” is performed. That is, the image switching unit 25 performs switching from the currently displayed image G to another image G. In a case where one of the horizontal and vertical components as the movement amount is larger than the switching threshold, the image switching is performed in a direction based on the one of the horizontal and vertical components. In a case where both of the horizontal and vertical components as the movement amount are larger than the switching threshold, image switching is performed in a direction based on a larger one of the horizontal and vertical components. To perform the image switching, the image switching unit 25 gives the image processing unit 13 an instruction to draw another image.

On the other hand, in step S34, “original image display” is performed. That is, the image switching unit 25 does not perform image switching but instructs the image processing unit 13 to continue with the drawing of the original image G.

When steps S33 and S34 are completed in this way, in either case, the image switching processing is completed.

[Advantages of Example 1]

The display device 11 of Example 1 includes the image-drawing processing unit 13 that draws an image G on the screen 3a of the image forming apparatus 1 at an image-drawing interval based on the processing capacity of the image forming apparatus 1, the selection receiving unit 15 that receives selection of the image G drawn on the screen 3a, the movement detecting unit 17 that detects a movement of the selection position with respect to the image G on the screen 3a in the state where the image G has been selected, the movement processing unit 19 that makes the image G move following the movement of the selection position that has been detected, the processing capacity determining unit 27 that determines whether or not the processing capacity of the image forming apparatus 1 is equal to or lower than the first threshold, and the movement managing unit 29 that performs movement management in which, in a case where the processing capacity is found to be equal to or lower than the first threshold, the movement managing unit prohibits the image G from moving when followability of the image G with respect to the movement of the selection position falls out of the acceptable range based on the image-drawing interval.

Thus, in Example 1, it is possible to prevent flickering of the image G by managing the movement of the image G based on the processing capacity of the image forming apparatus 1 to appropriately prohibit the image G from moving when its followability falls out of the acceptable range, and to allow the image G to move when its followability falls within the acceptable range.

The processing capacity determining unit 27 determines whether the processing capacity is the low capacity that is equal to or lower than the first threshold, the medium capacity that is higher than the first threshold but equal to or lower than the second threshold, or the high capacity that is higher than the second threshold. The movement managing unit 29, in the movement management, prohibits the movement of the image G in the case where the processing capacity is the low capacity, and allows the movement of the image G in the case where the processing capacity is the medium or high capacity.

In particular, the movement managing unit 29 of Example 1 sets the image-drawing interval long in the case of the medium capacity based on the amount of resource consumption that increases with respect to that of the case of the high capacity, and makes the image processing unit 13 draw the moving image G at the set image-drawing interval.

Thus, in Example 1, by sorting the processing capacities of the image forming apparatus 1 into the low capacity, the medium capacity, and the high capacity based on the first and second thresholds, it is made possible to appropriately manage the movement of the image G based on the processing capacity of the image forming apparatus 1.

Specifically, in the case of the high capacity, it is possible to draw the moving image G at an image-drawing interval that is equal or close to the upper-limit image-drawing interval based on the processing capacity, and this makes is possible to make the image G move smoothly following the movement of the finger.

In the case of the medium capacity, the movement managing unit 29 forcibly sets the image-drawing interval long, based on the amount of resource consumption that increases with respect to that of the case of the high capacity, and thus it is possible to eliminate risk of the amount of resource consumption being exclusively allotted to the drawing the image at the same image-drawing interval as in the case of the high capacity, and this makes it possible to perform the processing of making the image G move, along with other processing, while ensuring a stable operation of the image forming apparatus 1.

In the case of the low capacity, it is possible to appropriately prohibit the image G from moving.

Furthermore, in Example 1, the processing capacity determining unit 27 determines the processing capacity that varies based on the resource consumption while the image forming apparatus 1 is in operation, and the movement managing unit 29 performs movement management based on the judgment made on the processing capacity of the image forming apparatus 1 in operation.

Thus, in Example 1, even when the processing capacity of the image forming apparatus 1 varies during the operation, it is possible to prevent flickering of the image G appropriately and securely in response to the variation of the processing capacity.

The processing capacity determining unit 27 determines the processing capacity of the image forming apparatus 1 during operation by means of the actual value of the frame rate measured immediately before the image G moves, or by means of the specific processing capacity of the image forming apparatus 1 and the amount of resource consumption.

Thus, in Example 1, an accurate judgment can be made on the processing capacity of the image forming apparatus 1.

### Example 2

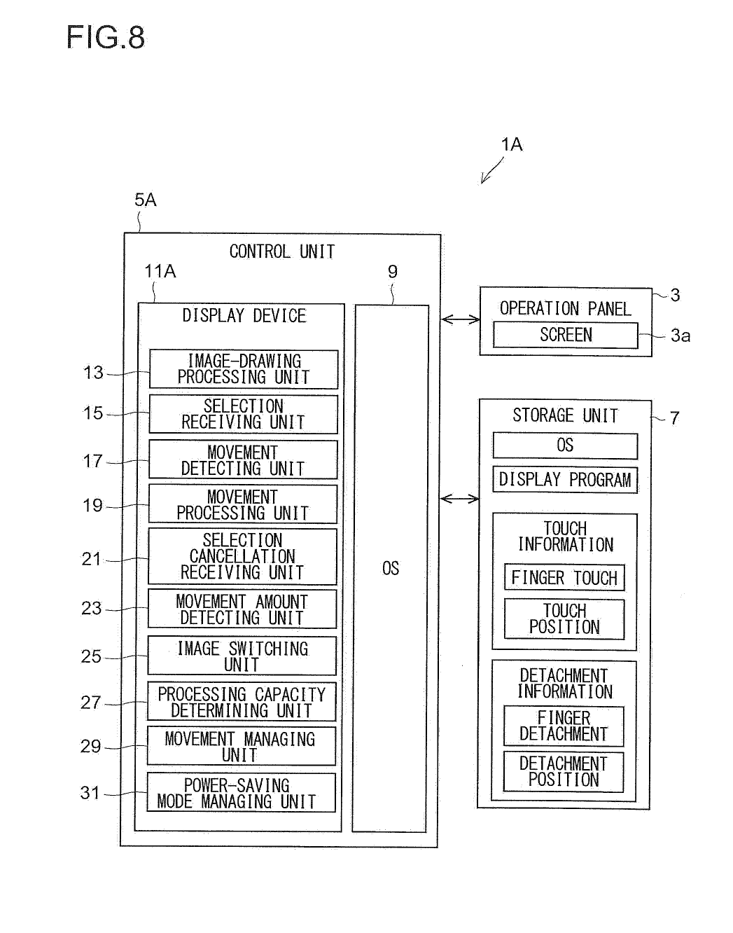

FIG. 8 illustrates an image forming apparatus in which a display device is incorporated. Here, in Example 2, such components as find their counterparts in Example 1 are identified by the common reference signs or the common reference signs followed by letter A, and overlapping descriptions thereof will be omitted.

An image forming apparatus 1A of Example 2 has a power saving mode. Thus, a control unit 5A as the display device 11A functions also as a power-saving mode managing unit 31.

The power-saving mode managing unit 31 realizes a power-saving mode managing function, and makes the image forming apparatus 1A shift to the power saving mode or recover from the power-saving mode. The shift to the power saving mode is triggered, for example, when a specific time has passed without any operation input with respect to the image forming apparatus 1A, or when an operation to shift to the power saving mode is performed. The recovery from the power saving mode is triggered, for example, when an operation input is performed with respect to the image forming apparatus 1A.

To make a shift to the power saving mode, the power-saving mode managing unit 31 lowers the arithmetic capacity by, for example, lowering the clock frequency of the control unit 5, or lowers resource capacity. Thus, in the power saving mode, the processing capacity of the image forming apparatus 1A is lowered. On the other hand, to allow recovery from the power saving mode, the power-saving mode managing unit 31 brings the processing capacity of the control unit 5 back to its original state. Thus, in the image forming apparatus 1A, the processing capacity varies along with the shift to the power saving mode and the recovery from the power saving mode.

In Example 2, it is possible to determine the processing capacity of the image forming apparatus 1A taking the power saving mode into consideration, by performing the capacity determining processing as in Example 1 during the operation of the image forming apparatus 1A. Thus, in Example 2, it is possible to manage the movement of the image G more securely based on the processing capacity of the image forming apparatus 1A, and to prevent flickering of the image G more appropriately.

[Others]

The above examples have been described, dealing with cases where the swipe operation is performed by a finger on the touch-panel type screen 3a, but the above examples are applicable to a case of a swipe operation by means of a pointing device such as a mouse.

What is claimed is:

1. A display device comprising a processor having one or more circuits,
the processor comprising
an image-drawing processing unit that draws an image on a screen of an apparatus at an image-drawing interval based on a processing capacity of the apparatus,
a selection receiving unit that receives selection of the image drawn on the screen,
a movement detecting unit that detects, in a state where the image has been selected, a movement of a selection position with respect to the image on the screen,
a movement processing unit that makes the image move following the movement of the selection position that has been detected,
a processing capacity determining unit that determines whether or not the processing capacity is equal to or lower than a first threshold, and
a movement managing unit that performs movement management in which, in a case where the processing capacity is found to be equal to or lower than the first threshold, the movement managing unit prohibits the image from moving when followability of the image with respect to the movement of the selection position falls out of an acceptable range based on the image-drawing interval.

2. The display device according to claim 1,
wherein
the processing capacity determining unit determines whether the processing capacity is a low capacity that is equal to or lower than the first threshold, a medium capacity that is higher than the first threshold but equal to or lower than a second threshold that is higher than the first threshold, or a high capacity that is higher than the second threshold, and
the movement managing unit, as the movement management, prohibits the image from moving in a case where the processing capacity is the low capacity, and allows the image to move in a case where the processing capacity is the medium capacity and in a case where the processing capacity is the high capacity.

3. The display device according to claim 2,
wherein
the movement managing unit sets the image-drawing interval of the case of the medium capacity long based on an amount of resource consumption that increases with respect to the amount of resource consumption of the case of the high capacity, and makes the image processing unit draw the moving image at the image-drawing interval that has been set.

4. The display device according to claim 1,
wherein
the processing capacity varies based on an amount of resource consumption of the apparatus during operation,
the processing capacity determining unit determines the processing capacity of the apparatus during operation, and
the movement managing unit performs the movement management based on the processing capacity of the apparatus during operation that has been judged.

5. The display device according to claim 4,
wherein
the processing capacity determining unit determines the processing capacity of the apparatus during operation based on an actual value of a frame rate measured immediately before the image moves, or based on the specific processing capacity of the apparatus and the amount of resource consumption.

6. A non-transitory computer-readable recording medium having stored therein a display program runnable on a computer,
the display program makes a computer realize
an image-drawing processing function of drawing an image on a screen of an apparatus at an image-drawing interval based on a processing capacity of the apparatus,
a selection receiving function of receiving selection of the image drawn on the screen,
a movement detecting function of detecting, in a state where the image has been selected, a movement of a selection position with respect to the image on the screen,
a movement processing function of making the image move following the movement of the selection position that has been detected,
a processing capacity determining function of determining whether the processing capacity is equal to or lower than a first threshold, and
a movement managing function of performing movement management in which, in a case where the processing capacity is equal to or lower than the first threshold, the image is prohibited from moving when followability of the image with respect to the movement of the selection position falls out of an acceptable range based on the image-drawing interval.
